(19) United States
(12) Patent Application Publication
(10) Pub. No.: US 2011/0307842 A1
(43) Pub. Date: Dec. 15, 2011

(54) ELECTRONIC READING DEVICE

(76) Inventors: I-Jen CHIANG, Taipei (TW); Yi-Kung Chen, Taipei (TW)

(21) Appl. No.: 12/814,929

(22) Filed: Jun. 14, 2010

(51) Int. Cl. G06F 3/033; G09G 5/00; G02C 11/00

(52) U.S. Cl. 715/863; 345/156; 351/158

(57) ABSTRACT

This invention provides an electronic reading device which comprises an eye glass frame and a camera-projection component mounted on the eye glass frame comprising a projection unit to project an image onto a projection surface and an optical sensor unit to perform a scan of a region near the projection surface, wherein the optical sensor unit is configured to operate as a user interface by detecting a user input based on the scan. The electronic reading device could create the same page-reading experience as well as page-turning experience on to every surface such as walls, tables, or other kinds of panels as reading a conventional book, i.e. simulating “page turning like a real paper book”.

### BACKGROUND OF THE PRESENT INVENTION

1. Field of Invention

The present invention relates to an electronic device, and more particularly to an electronic reading device, sometimes called an e-reader, such as electronic books.

2. Description of Related Arts

As described in U.S. Pub. No. 2008/0259057, electronic content in the form of text and illustrations is increasingly available. While it is already feasible to read all our documents from our computer screens, we still prefer to read from paper prints. As a consequence, an increased amount of paper prints are generated, increasing inconvenience to consumers and increasing paper waste. Reading on an electronic device such as Laptop PC, PDA, mobile phone or e-reader has been an alternative for many years but people don't read with these devices for hours. Also various e-reading devices specifically designed for portable reading have been commercially available. These screens are usually based on liquid crystal displays (further also referred to as LCD) containing backlights and double glass plate. Reflective LCD has recently been used as the display screen for e-readers, but reading performance deviates largely from the real paper prints.

Only the Sony Librie e-reader, introduced in the market since April 2004, used a paper-like screen based on electrophoretic display, having identical reading performance as conventional paper prints: high readability, low power consumption, thin, and lightweight. The use of such paper-like display could bring a breakthrough in reading electronic content on an electronic reading device. To reach such a breakthrough, it is very important to create the same page-turning experience as reading a conventional book, i.e. simulating “page turning like a real paper book”. Without such a page turning experience, reading from an electronic display still remains “controlling an electronic device”. Accordingly, this prior art provides an electronic reading device, which creates to the user the same page-turning experience as reading a conventional book.

In addition, as described in U.S. Pub. No. 2008/0174570, as portable electronic devices become more compact, and the number of functions performed by a given device increase, it has become a significant challenge to design a user interface that allows users to easily interact with a multifunction device. This challenge is particular significant for handheld portable devices, which have much smaller screens than desktop or laptop computers. This situation is unfortunate because the user interface is the gateway through which users receive not only content but also responses to user actions or behaviors, including user attempts to access a device's features, tools, and functions. Some portable communication devices (e.g., mobile telephones, sometimes called mobile phones, cell phones, cellular telephones, and the like) have resorted to adding more pushbuttons, increasing the density of push buttons, overloading the functions of pushbuttons, or using complex menu systems to allow a user to access, store and manipulate data. These conventional user interfaces often result in complicated key sequences and menu hierarchies that must be memorized by the user.

Many conventional user interfaces, such as those that include physical pushbuttons, are also inflexible. This may prevent a user interface from being configured and/or adapted by either an application running on the portable device or by users. When coupled with the time consuming requirement to memorize multiple key sequences and menu hierarchies, and the difficulty in activating a desired pushbutton, such inflexibility is frustrating to most users.

To avoid problems associated with pushbuttons and complex menu systems, portable electronic devices may use touch screen displays that detect user gestures on the touch screen and translate detected gestures into commands to be performed. However, user gestures may be imprecise; a particular gesture may only roughly correspond to a desired command. Other devices with touch screen displays, such as desktop computers with touch screen displays, also may have difficulties translating imprecise gestures into desired commands.

Accordingly, the prior art provides touch-screen-display electronic devices with more transparent and intuitive user interfaces for translating imprecise user gestures into precise, intended commands that are easy to use, configure, and/or adapt. Such interfaces increase the effectiveness, efficiency and user satisfaction with portable multifunction devices.

The use of such techniques disclosed in the previous arts could bring a breakthrough in reading electronic content on an electronic reading device. Especially, the use of such touch-screen-display electronic devices with more transparent and intuitive user interfaces for translating imprecise user gestures into precise, intended commands that are easy to use, configure, and/or adapt. Such interfaces could create the same page-turning experience as reading a conventional book, i.e. simulating “page turning like a real paper book”. Such paper-like screens could create the same identical reading performance as conventional paper prints: high readability, low power consumption, thin, and lightweight. Accordingly, to reach such a breakthrough, it is very important to use such interfaces and paper-like screens to create the same page-turning experience as reading a conventional book, i.e. simulating “page turning like a real paper book”.

Even though the use of such interfaces and paper-like screens could bring a breakthrough in reading electronic content on an electronic reading device, there is still a desire for improved electronic reading devices. The advent of novel sensing and display technology has encouraged the development of a variety of electronic reading devices which could create the same page-reading experience as well as page-turning experience on to every surface such as walls, tables, or other kinds of panels as reading a conventional book, i.e. simulating “page turning like a real paper book”. It would thus be desirable to provide electronic reading devices in order to create the same page-reading experience as well as page-turning experience on to every surface such as walls, tables, or other kinds of panels as reading a conventional book, i.e. simulating “page turning like a real paper book”.

### SUMMARY OF THE PRESENT INVENTION

A main object of the present invention is to provide an electronic reading device which could create the same page-reading experience as well as page-turning experience on to every surface such as walls, tables, or other kinds of panels as reading a conventional book, i.e. simulating “page turning like a real paper book”.

Another object of the present invention is to provide an electronic reading device which has the form of an eye glass. Typically, such devices include a conventional spectacle frame, the camera-projection component mounted on the spectacle frame. The purpose of such devices was to eliminate the need for the wearer of the eye glasses to carry a separate electronic reading device, and such devices thereby free the hands for other useful purposes.

Another object of the present invention is to provide an electronic reading device which could display electronic documents onto a projection surface and allows a user to interact with electronic documents projected onto the projection surface by touching the projection surface with the user's fingers.

Another object of the present invention is to provide an electronic reading device which could facilitate determining whether an object is touching or hovering over the projection surface in connection with the electronic reading device.

Another object of the present invention is to provide an electronic reading device which could observe finger shadow(s) as they appear on an interactive (or projection) surface and determine whether the one or more fingers are touching or hovering over the projection surface.

Another object of the present invention is to provide an electronic reading device further comprising a connection unit to establish a connection to an electronic device, wherein the electronic reading device being configured to operate as a display unit and as a user interface for the electronic device.

Accordingly, in order to accomplish the one or some or all above objects, the present invention provides an electronic reading device, comprising:

an eye glass frame; and

a camera-projection component mounted on the eye glass frame, comprising:
a projection unit to project an image onto a projection surface; and
an optical sensor unit to perform a scan of a region near the projection surface, wherein the optical sensor unit is configured to operate as a user interface by detecting a user input based on the scan.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1A illustrates an embodiment of an electronic reading device in accordance with the present invention.

FIG. 1B illustrates the projection surface projected by an electronic reading device in accordance with the present invention.

FIG. 1C illustrates exemplary electronic contents on a projection surface projected by the electronic reading device in accordance with the present invention.

FIG. 1D shows the block diagram of the camera-projection component in accordance with the present invention.

FIG. 2 illustrates another embodiment of an electronic reading device in accordance with the present invention.

FIG. 3A illustrate another embodiment of an electronic reading device in accordance with the present invention.

FIG. 3B illustrates a projection surface projected by an electronic reading device in accordance with the present invention.

FIG. 3C illustrates exemplary user interfaces for a menu of applications on a projection surface projected by an electronic reading device in accordance with the present invention.

FIG. 3D shows the block diagram of the electronic reading device in accordance with the present invention.

### DETAILED DESCRIPTION OF THE PREFERRED EMBODIMENT

Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

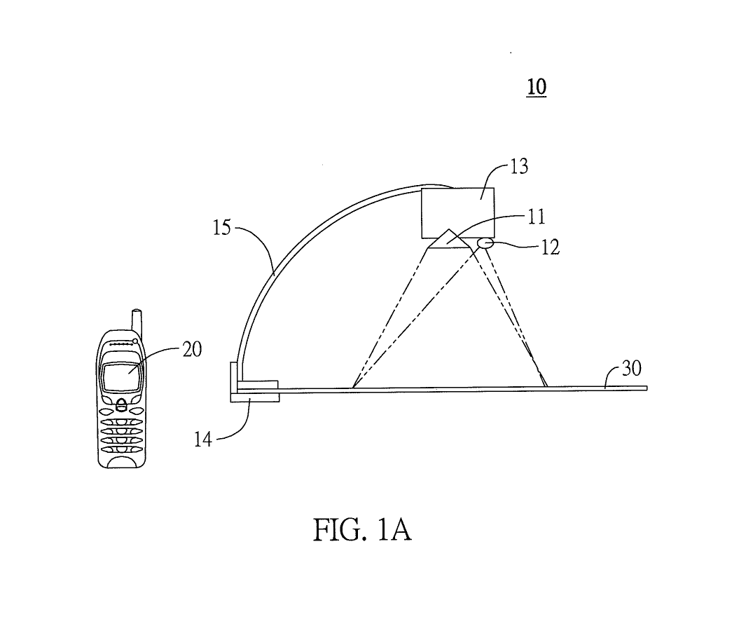

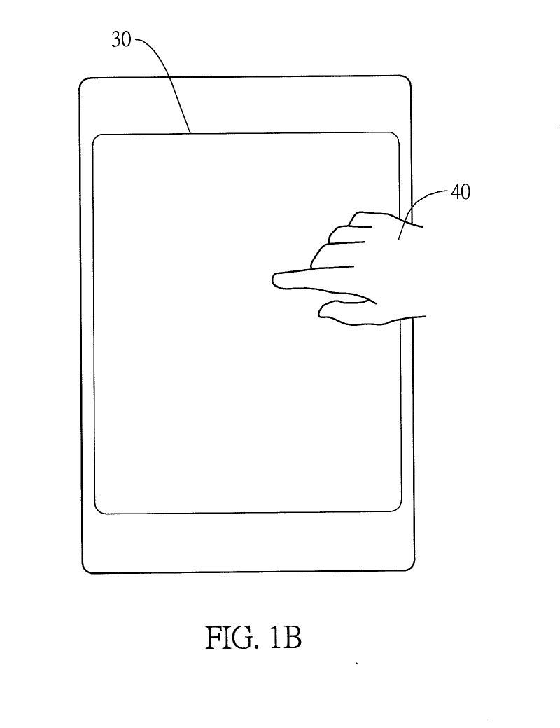

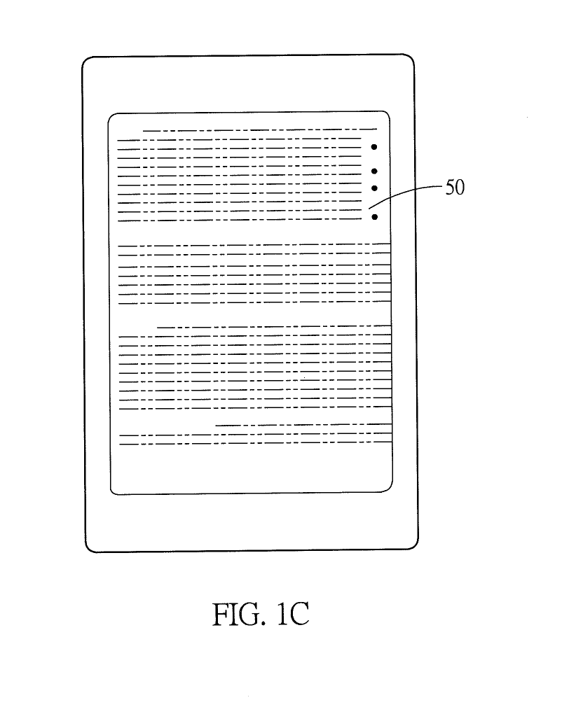

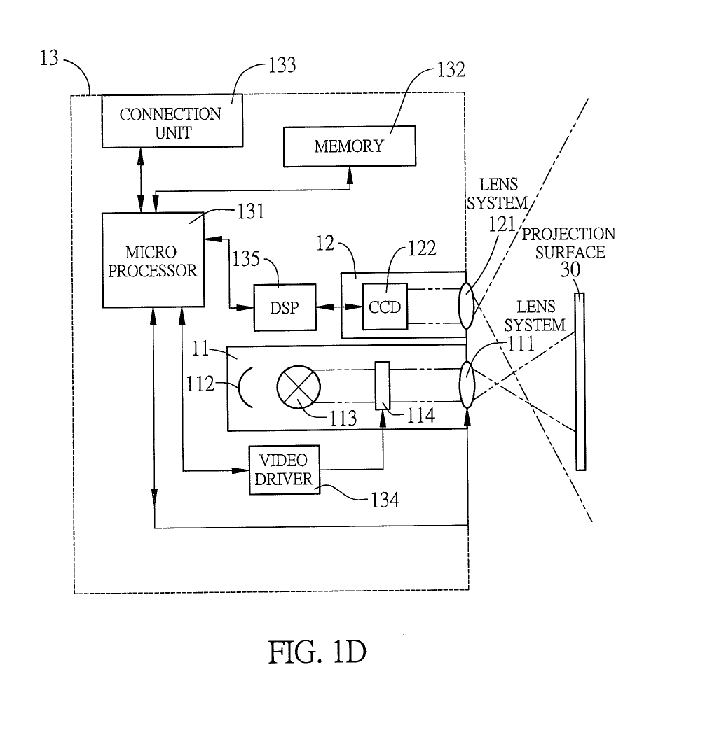

Referring to FIG. 1A illustrates an embodiment of an electronic reading device in accordance with the present invention. The electronic reading device 100 could display electronic documents onto a projection surface 30. The electronic reading device 10 allows a user to interact with electronic documents projected onto the projection surface 30 by touching the projection surface 30 with the user's fingers. The electronic reading device 10 could facilitate determining whether an object is touching or hovering over the projection surface 30 in connection with the electronic reading device 10. The electronic reading device 10 could observe finger shadow(s) as they appear on an interactive (or projection) surface 30. One or more shadow images can be computed and based on those images, the electronic reading device 10 can determine whether the one or more fingers are touching or hovering over the projection surface 30. When either a hover or touch operation is determined, an appropriate action can follow. For example, if the hover is detected over a particular area of the interactive surface, it can trigger a menu to appear on the surface. A user can select menu options by using touch (e.g., touching the option to select it). Alternatively, hovering can prompt a selection to be made or can prompt some other pre-set operation to occur. Similar programming can be done with respect to a detected touch on the surface.

The electronic reading device 10 having the capability to recognize a user input by optical means may be used as a display and input unit for a mobile electronic device 20. In an embodiment, the electronic device to which the connection is established is a mobile electronic device selected from the group comprising a cellular phone, a personal digital assistant (PDA), a personal navigation device (PND), a portable computer, an audio player, and a mobile multimedia device.

The electronic reading device 10 establishes for example a wireless connection with the mobile electronic device 20. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document. The connection is then used to transmit video signals or still image signals, for example electronic contents in the form of text and illustrations, from the mobile electronic device 20 to the electronic reading device 10, and to transmit input data from the electronic reading device 10 to the mobile electronic device 20.

Referring to FIG. 1A, the electronic reading device 10 comprises a bendable arm 15 and a holder 14. The bendable arm 15 is utilized for connecting the holder 140 to a camera-projection component 13. The holder 14 is utilized for securing with the projection surface 30. The projection surface 30 may for example be a surface of a sheet of paper, a desktop surface, or a surface of a plastic plate. The camera-projection component 13 further comprises a projection unit 11 and an optical sensor unit 12. The projection unit 11 is utilized to project video signals or still image signals from the mobile electronic device 20 to the electronic reading device 10. The optical sensor unit 12 may perform a scan of a region near the projection surface, wherein the optical sensor unit is configured to capture still images or video as a user interface by detecting a user input based on the scan. The electronic reading device 10 could facilitate determining whether an object is touching or hovering over the projection surface 30 in connection with the electronic reading device 10 by the captured still images or video. Therefore, the electronic reading device 10 could observe finger shadow(s) as they appear on an interactive (or projection) surface 30. One or more shadow images can be computed and based on those images, the electronic reading device 10 can determine whether the one or more fingers are touching or hovering over the projection surface 30. When either a hover or touch operation is determined, an appropriate action can follow. For example, if the hover is detected over a particular area of the interactive surface, it can trigger a menu to appear on the surface. A user can select menu options by using touch (e.g., touching the option to select it). Alternatively, hovering can prompt a selection to be made or can prompt some other pre-set operation to occur. Similar programming can be done with respect to a detected touch on the surface.

In some embodiments, the contact may include a gesture, such as one or more taps, one or more swipes (from left to right, right to left, upward and/or downward) and/or a rolling of a finger (from right to left, left to right, upward and/or downward) that has made contact with the projection surface 30.

Hence the electronic reading device 10 could detect user gestures on the projection surface 30 and translate detected gestures into commands to be performed. One or more swipes (from left to right, right to left, upward and/or downward) and/or a rolling of a finger (from right to left, left to right, upward and/or downward) that has made contact with the projection surface 30 may create the same page-turning experience as reading a conventional book, i.e. simulating “page turning like a real paper book”. Such electronic reading device 10 could create the same identical reading performance as conventional paper prints: high readability, low power consumption, thin, and lightweight. Accordingly, to reach such a breakthrough, it is very important to use such interfaces to create the same page-turning experience as reading a conventional book, i.e. simulating “page turning like a real paper book”.

FIG. 1B illustrates the projection surface 30 projected by an electronic reading device 10 in accordance with the present invention. FIG. 1C illustrates exemplary electronic contents 50 on a projection surface 30 projected by the electronic reading device 10 in accordance with the present invention. The electronic reading device 10 could display one or more electronic contents 50 onto the projection surface 30. In this embodiment, a user may use one or more swipes (from left to right, right to left, upward and/or downward) and/or a rolling of a finger (from right to left, left to right, upward and/or downward) that has made contact with the projection surface 30 may create the same page-turning experience as reading a conventional book, i.e. simulating “page turning like a real paper book”.

FIG. 1D shows the block diagram of the camera-projection component 13 in accordance with the present invention. The microprocessor 131 controls the operation of the electronic reading device 10 according to programs stored in a memory 132. The memory 132 may incorporate all known kinds of memory, such as random access memory (RAM), read only memory (ROM), flash memory, EPROM or EEPROM memory, or a hard drive. Non-volatile memory may be used to store computer program instructions according to which the electronic reading device 10 works. The microprocessor 131 may be implemented as a single microprocessor, or as multiple microprocessors, in the form of a general purpose or special purpose microprocessor, or a digital signal processor. In the embodiment of FIG. 1D, a picture processing unit, a correction unit, and a stabilization unit are implemented as software instructions being executed on microprocessor 131. The functioning of these units will be explained in detail later.

The microprocessor 131 interfaces the connection unit 133, e.g. by means of a bus system, an input/output unit, or the Bluetooth™/® technology (not shown). Via the connection unit 133, a connection to an electronic device, such as a mobile electronic device, could be established through a connection cable (not shown) or wireless communication technology. The wireless communication technology is as described above.

The electronic device 20 transmits a display signal, for example electronic documents, via the connection unit 133, the display signal being processed by microprocessor 131. The display signal is supplied by the microprocessor 131 to a video driver 134, e.g. via a data bus. The video driver 134 controls a projection unit 11. The projection unit 11 may for example comprise a light source and a display element, such as an LCD element, and is capable of projecting an image by using a lens system 111. In this embodiment, the projection unit 11 comprises a reflector 112, a lamp 113, a LCD element 114, and the lens system 111. Those skilled in the art will appreciate that the projection unit 11 may comprise further elements, such as polarizers, mirrors, an illumination lens system and the like. The lamp 310C may be implemented as one or more light emitting diodes (LED's) or organic LED's (oLED's), and illuminates the LCD element 114.

The video driver 134 delivers a control signal to the LCD element 114, which forms an image in accordance with the signal, the image being projected by the lens system 111 onto the projection surface 30. The lens system 111 may comprise several optical lenses, depending on the desired optical properties of the lens system, which may be optimized for minimizing aberrations. The lens system 111 may further comprise movable lenses, which may be used to adjust the focus and the focal length of the lens system, yet they may also provide compensation for a movement of the electronic reading device 10. Further, lenses may be moved in order to adjust the direction into which the image is projected. The projection surface 30 may for example be a surface of a sheet of paper, a desktop surface, or a surface of a plastic plate.

The lens system 121 is a wide angle lens system, so that picture data of the surroundings of the electronic reading device 10 can be captured over a large angular region. The sensor data supplied by the CCD 122 are then processed by a digital signal processor 134, and supplied to the microprocessor 131. Instead of the CCD 122, a CMOS sensor or a PMD sensor may also be used. Using a wide angle lens system, the optical sensor unit 12 is enabled to locate the projection surface 30, even if a large relative movement between the projection surface 30 and the electronic reading device 10 occurs. Raw image data provided by the CCD 122 is processed by the DSP 135, and the resulting captured picture data is supplied to the microprocessor 131. Instead of the DSP 135, the microprocessor 131 may not only be implemented as a single microprocessor but also as a digital signal processor.

A person skilled in the art will appreciate that the projecting of an image may be implemented in a variety of ways. The video driver 134 may for example be implemented with microprocessor 131. As projecting an image in accordance with a received video signal is known in the art, the processing of the video signal and the projecting will not be described in greater detail here.

The electronic reading device 10 further comprises an optical sensor unit 12. The optical sensor unit 12 may comprise a CCD sensor, a CMOS sensor, a PND sensor or the like. It scans the region surrounding the electronic reading device 10 by capturing a picture of the surrounding of the projection unit 11 through the lens system 121. The optical sensor unit 12 may thus be implemented as a camera unit. The picture data captured by the optical sensor unit 12 is supplied to the microprocessor 131. The picture processing unit analyzes the picture data for a user controlled object. For this purpose, image processing is employed. The picture processing unit may for example use an edge detection algorithm for detecting features in the picture data, and it may use a recognition algorithm for recognizing objects in the captured image data. The picture processing unit may for example be configured to recognize a range of predetermined objects, such as a hand, a finger, a pen, a ring or a reflector. If for example a hand is placed in front of lens system 121, the captured picture data comprises an image of the hand, which may then be recognized by the picture processing unit. The picture processing unit further detects a variation of a user controlled object and interprets it as a user input. Accordingly, a control signal is generated by the picture processing unit, in response to which the microprocessor 131 initiates the projecting of a video signal received from the connection unit 133 via the video driver 134 and the projecting unit 11. The picture processing unit may furthermore recognize the movement of a particular object, and interpret it as a command. Examples are the pointing to a particular position with a finger, the pushing of a particular position on the projection surface, e.g. the palm, with the finger or a pen.

The pushing of a particular position on the projection surface 30, e.g. with the finger or a pen, allows a user to operate the device with similar experience as reading a conventional paper book when turning a page. One may flick a book through the pages back and forth by pushing of a particular position on the projection surface 30 from left to right or from right to left with e.g. one's thumb (e.g. in case of portrait usage mode). This would bring “paper like reading” experience to the user. To completely mimic this page turning, the pushing of a particular position on the projection surface 30 could result in the electronic documents rotating around an axes upon the pushing action. Further, the picture processing unit may be configured to analyze shadows cast by a user controlled object, e.g. a finger. When the finger touches the projection surface, the shadow of the finger matches the finger. This can be detected as a user command.

The correction unit further analyzes properties of the projection surface imaged in the picture data supplied by the optical sensor unit 12. For example, when using a surface of a plastic plate or a desktop surface as a projection surface, the projection surface has a particular texture, color and curvature. The correction unit determines these properties, e.g. using image analysis, and performs a correction of the video signal supplied by the correction unit, so that the quality of the image projected by the projection unit 11 is improved. The correction unit may make use of any known image correction method in order to optimize the projected image. The correction unit may for example perform a color correction of the image, so that even on a colored projection surface the colors of the image are displayed as desired. For correction purposes, the correction unit may also work in a feedback configuration, wherein the properties of the projected image are tuned until the projected image exhibits the desired properties. The feedback signal in the form of captured picture data is delivered by the optical sensor unit 12 in this configuration.

The stabilization unit stabilizes the projecting of the image onto the projection surface 30. The stabilization unit may for example monitor the position of the projection surface in the captured picture data received from the optical sensor unit 12. The stabilization unit is implemented to drive a lens of a lens system 111 for image stabilization. By moving a lens of the lens system 111, e.g. in a plane perpendicular to the optical axis of the lens system, the direction in which the image is projected, can be adjusted. The adjusting is performed by the stabilization unit in such a way that the image is stabilized on the projection surface 30. The stabilization unit may for example receive information on the position of the projection surface 30 from the microprocessor 131, and may then in accordance with that information send control signals to the lens system 111. In another embodiment, the stabilization unit may comprise sensors for detecting a movement of the electronic reading device 10, such as inertial or motion sensors, data from which sensors is then used for stabilization purposes. In a further embodiment, an active mirror controlled by the stabilization unit may be used in order to adjust the position of the projected image. Those skilled in the art will appreciate that there are several possibilities of implementing the image stabilization, and that different methods may be combined, such as performing stabilization using a software running on the microprocessor 131, or performing active stabilization using an electrically actuated mirror or moving lens. Those skilled in the art will appreciate that several other techniques for realizing such image stabilization may also be implemented in the electronic reading device of the present embodiment, e.g. stabilization by optical means.

Accordingly, by processing the picture data captured with the optical sensor unit 320 using the microprocessor 131, image correction and image stabilization can be performed, and user inputs can be detected. User commands detected by the picture processing unit are then supplied to the electronic device via the connection unit 133 and the connection cable or the Bluetooth™/® technology (not shown). In another embodiment, the captured picture data may be directly supplied to the electronic device, so that the electronic device can analyze the picture data for user commands.

The electronic reading device 10 of the present embodiment thus provides a display and user interface unit for an electronic device. It can be constructed in a small size and lightweight, so that it is easy to use. As an electronic device using such an electronic reading device does not require additional input or display means, the size of the electronic device can be reduced. It should be clear that the electronic reading device 10 may comprise further components, such as a battery, an input/output unit, a bus system, etc., which are not shown in FIGS. 1A and 1D for clarity purposes.

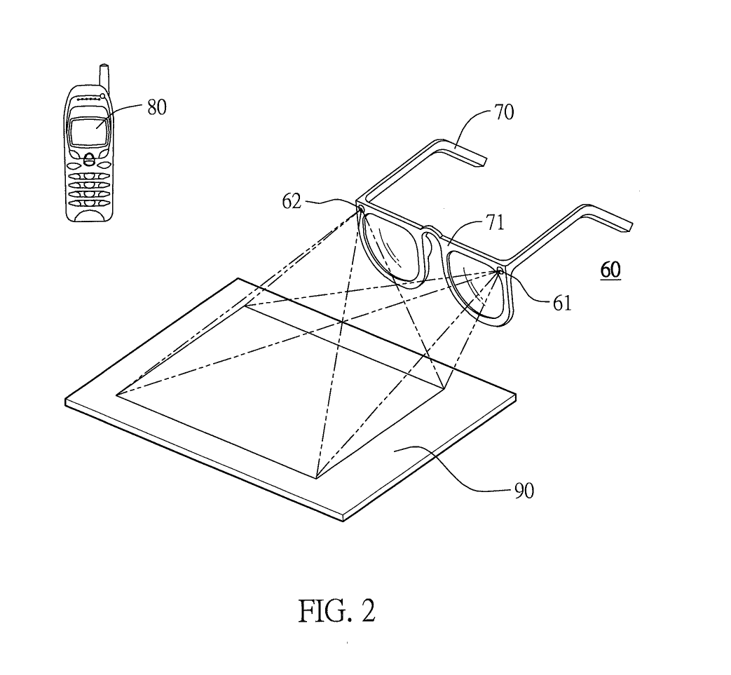

Referring to FIG. 2 illustrates another embodiment of an electronic reading device in accordance with the present invention. The electronic reading device has the form of an eye glass 70. The electronic reading device 60 again comprises a camera-projection component. The spectacle or eye glass frames 71 have been developed which include the camera-projection component for reading electronic documents. The camera-projection component comprises a projection unit 61 for projecting an image, and an optical sensor unit 62 for capturing picture data. Typically, such devices include a conventional spectacle frame, the camera-projection component mounted on the spectacle frame. The purpose of such devices was to eliminate the need for the wearer of the eye glasses to carry a separate electronic reading device, and such devices thereby free the hands for other useful purposes. The electronic reading device 60 communicates with an electronic device 80. In the present embodiment, the electronic device 80 is implemented as a cellular phone, yet it may be implemented as any other electronic device, such as a PDA, an audio player, a portable computer, and the like. Preferably, the electronic device 80 is a mobile electronic device. The electronic reading device 60 operates both as display unit and user interface for cellular phone 70. Accordingly, the cellular phone 70 does not need to be provided with a display and control elements/a keyboard. The cellular phone 70 sends a display signal to the electronic reading device 60 and receives user commands detected by the electronic reading device 60. Again, the electronic reading device 60 may operate in a passive state until detecting a turn-on command, such as an open hand, in response to which the sending of the display signal by the mobile electronic device 80 is initiated. The corresponding image 61 is then projected onto a surface 90 such as walls, tables, a sheet of paper, or other kinds of panels.

It should be clear that any other surface may be used as a projection surface, in particular as the electronic reading device 60 may be provided with means for correcting the projecting of the image so as to achieve a good image quality. As such, the projection surface may be a wall, a sheet of paper, and the like.

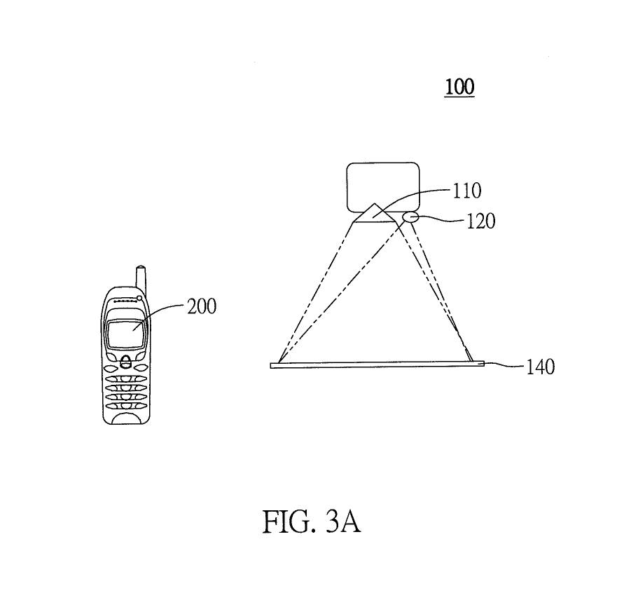

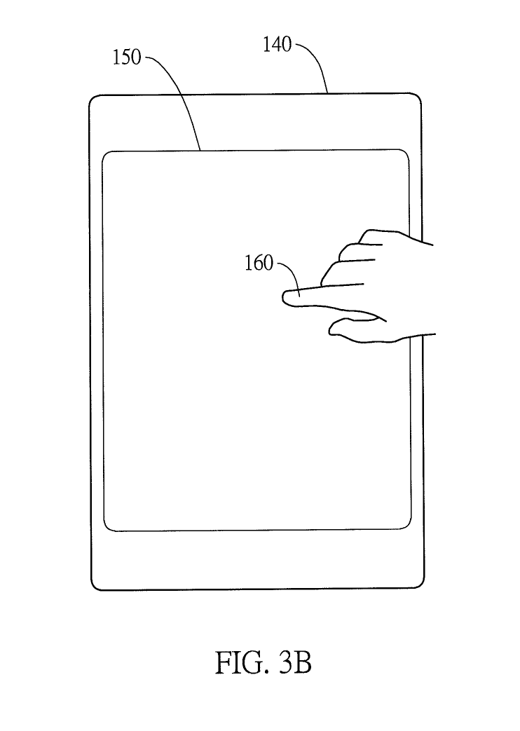

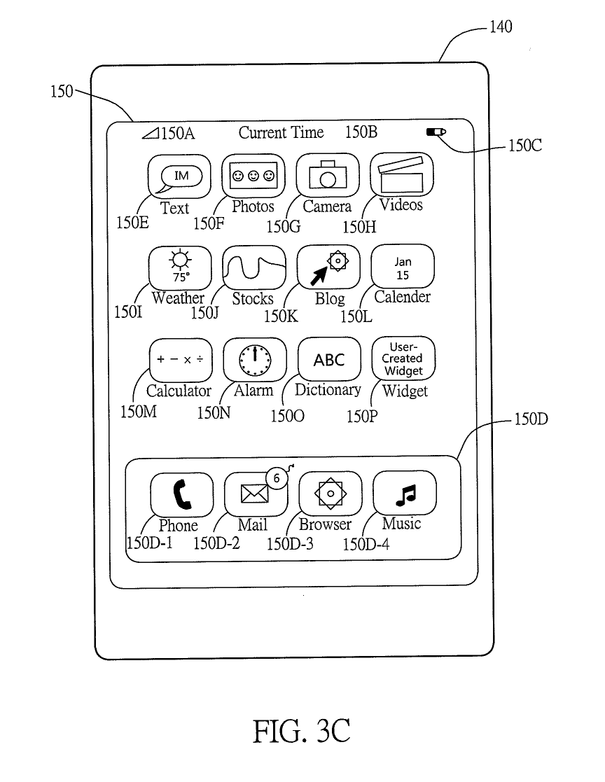

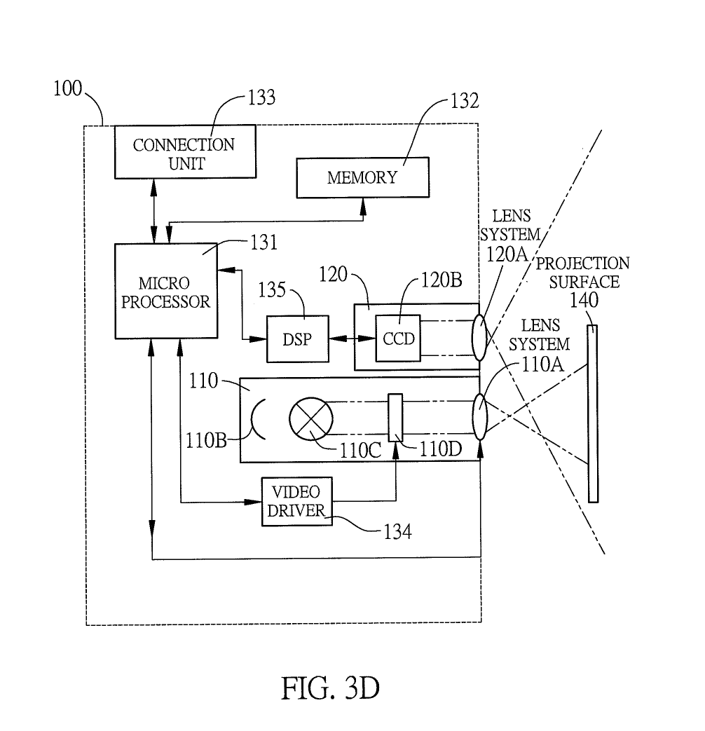

Referring to FIGS. 3A˜3D illustrate another embodiment of an electronic reading device in accordance with the present invention. The electronic reading device 100 could display electronic documents onto a projection surface 140. The electronic reading device 100 allows a user to interact with electronic documents projected onto the projection surface 140 by touching the projection surface 140 with the user's fingers. The electronic reading device 100 could facilitate determining whether an object is touching or hovering over the projection surface 140 in connection with the electronic reading device 100. The electronic reading device 100 could observe finger shadow(s) as they appear on an interactive (or projection) surface 140. One or more shadow images can be computed and based on those images, the electronic reading device 100 can determine whether the one or more fingers 160 are touching or hovering over the projection surface 140. When either a hover or touch operation is determined, an appropriate action can follow. For example, if the hover is detected over a particular area of the interactive surface, it can trigger a menu to appear on the surface. A user can select menu options by using touch (e.g., touching the option to select it). Alternatively, hovering can prompt a selection to be made or can prompt some other pre-set operation to occur. Similar programming can be done with respect to a detected touch on the surface.

The electronic reading device 100 having the capability to recognize a user input by optical means may be used as a display and input unit for a mobile electronic device 200. In an embodiment, the electronic device to which the connection is established is a mobile electronic device selected from the group comprising a cellular phone, a personal digital assistant (PDA), a personal navigation device (PND), a portable computer, an audio player, and a mobile multimedia device. The electronic reading device 100 establishes for example a wireless connection with the mobile electronic device 200. The wireless communication technology is as described above. The connection is then used to transmit video signals or still image signals from the mobile electronic device 200 to the electronic reading device 100, and to transmit input data from the electronic reading device 100 to the mobile electronic device 200.

FIG. 3B illustrates a projection surface 140 projected by an electronic reading device 100 in accordance with the present invention. FIG. 3C illustrates exemplary user interfaces for a menu of applications on a projection surface 140 projected by an electronic reading device 100 in accordance with the present invention. The electronic reading device 100 could display one or more graphics onto the projection surface 140. In this embodiment, as well as others described below, a user may select one or more of the graphics by making contact or touching the graphics, for example, with one or more fingers 150 (not drawn to scale in the figure). In some embodiments, selection of one or more graphics occurs when the user breaks contact with the one or more graphics. In some embodiments, the contact may include a gesture, such as one or more taps, one or more swipes (from left to right, right to left, upward and/or downward) and/or a rolling of a finger (from right to left, left to right, upward and/or downward) that has made contact with the projection surface 140. In some embodiments, inadvertent contact with a graphic may not select the graphic. For example, a swipe gesture that sweeps over an application icon may not select the corresponding application when the gesture corresponding to selection is a tap.

As shown in FIG. 3C, in some embodiments, a user interface 150 includes the following elements, or a subset or superset thereof: Signal strength indicator(s) 150A for wireless communication(s), such as cellular and Wi-Fi signals; Time 150B; Battery status indicator 150C; Tray 150D with icons for frequently used applications, such as: Phone 150D-1, which may include an indicator of the number of missed calls or voicemail messages; E-mail client 150D-2, which may include an indicator of the number of unread e-mails; Browser 150D-3; and Music player 150D-4; and Icons for other applications, such as: IM 150E; Image management 150F; Camera 150G; Video player 150H; Weather 150I; Stocks 150J; Blog 150K; Calendar 150L; Calculator 150M; Alarm clock 150N; Dictionary 150O; and User-created widget 150P, such as this user interface and elements described in U.S. patent application Ser. No. 12/101,832, “Touch Screen Device, Method, and Graphical User Interface for Determining Commands by Applying Heuristics”, filed Apt 11, 2008.

In some embodiments, the user interface 150 displays all of the available applications on the projection surface 140 so that there is no need to scroll through a list of applications (e.g., via a scroll bar). In some embodiments, as the number of applications increase, the icons corresponding to the applications may decrease in size so that all applications may be displayed on a single screen without scrolling. In some embodiments, having all applications on the projection surface 140 enables a user to access any desired application with at most one input, such as activating the desired application (e.g., by a tap or other finger gesture on the icon corresponding to the application).

In some embodiments, the user interface 150 provides integrated access to both widget-based applications and non-widget-based applications. In some embodiments, all of the widgets, whether user-created or not, are displayed in the user interface 150. In other embodiments, activating the icon for user-created widget 150P may lead to another UI that contains the user-created widgets or icons corresponding to the user-created widgets.

In some embodiments, a user may rearrange the icons in the user interface 150, e.g., using processes described in U.S. patent application Ser. No. 11/459,602, “Portable Electronic Device with Interface Reconfiguration Mode,” filed Jul. 24, 2006, which is hereby incorporated by reference in its entirety. For example, a user may move application icons in and out of tray 150D using finger gestures.

In consequence, there is no need for the user of the electronic device 200 to actually access the electronic device 200, e.g. remove it from a pocket or bag, as the user is enabled to operate the device 200 simply by means of the electronic reading device 100.

FIG. 3D shows the block diagram of the electronic reading device 100 comprising a microprocessor 131 in accordance with the present invention. The microprocessor 131 controls the operation of the electronic reading device 100 according to programs stored in a memory 132. The memory 132 may incorporate all known kinds of memory, such as random access memory (RAM), read only memory (ROM), flash memory, EPROM or EEPROM memory, or a hard drive. Non-volatile memory may be used to store computer program instructions according to which the electronic reading device 100 works. The microprocessor 131 may be implemented as a single microprocessor, or as multiple microprocessors, in the form of a general purpose or special purpose microprocessor, or a digital signal processor. In the embodiment of FIG. 3D, a picture processing unit, a correction unit, and a stabilization unit are implemented as software instructions being executed on microprocessor 131. The functioning of these units will be explained in detail later.

The microprocessor 131 interfaces the connection unit 133, e.g. by means of a bus system. Via the connection unit 133, a connection to an electronic device, such as a mobile electronic device, could be established through a connection cable or a wireless communication. The wireless communication technology is as described above. The connection unit 133 may comprises a RF (radio frequency) circuitry (not shown) which receives and sends RF signals, also called electromagnetic signals. The RF circuitry converts electrical signals to/from electromagnetic signals and communicates with communications networks and other communications devices via the electromagnetic signals. The RF circuitry may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The electronic device 200 transmits a display signal via the connection unit 133, the display signal being processed by microprocessor 131. The display signal is supplied by the microprocessor 131 to a video driver 134, e.g. via a data bus. The video driver 134 controls a projection unit 110. The projection unit 110 may for example comprise a light source and a display element, such as an LCD element, and is capable of projecting an image by using a lens system 110A. In this embodiment, the projection unit 110 comprises a reflector 110B, a lamp 110C, a LCD element 110D, and the lens system 110A. Those skilled in the art will appreciate that the projection unit 110 may comprise further elements, such as polarizers, mirrors, an illumination lens system and the like. The lamp 110C may be implemented as one or more light emitting diodes (LED's) or organic LED's (oLED's), and illuminates the LCD element 110D.

The video driver 134 delivers a control signal to the LCD element 110D, which forms an image in accordance with the signal, the image being projected by the lens system 110A onto the projection surface 140. The lens system 110A may comprise several optical lenses, depending on the desired optical properties of the lens system, which may be optimized for minimizing aberrations. The lens system 110A may further comprise movable lenses, which may be used to adjust the focus and the focal length of the lens system, yet they may also provide compensation for a movement of the electronic reading device 100. Further, lenses may be moved in order to adjust the direction into which the image is projected. The projection surface 140 may for example be a surface of a wall, a sheet of paper, or the plastic plate.

The lens system 120A is a wide angle lens system, so that picture data of the surroundings of the electronic reading device 100 can be captured over a large angular region. The sensor data supplied by the CCD 120B are then processed by a digital signal processor 135, and supplied to the microprocessor 131. Instead of the CCD 120B, a CMOS sensor or a PMD sensor may also be used. Using a wide angle lens system, the optical sensor unit 120 is enabled to locate the projection surface 140, even if a large relative movement between the projection surface 140 and the electronic reading device 100 occurs. Raw image data provided by the CCD 120B is processed by the DSP 135, and the resulting captured picture data is supplied to the microprocessor 131. Instead of the DSP 135, the microprocessor 131 may not only be implemented as a single microprocessor but also as a digital signal processor.

A person skilled in the art will appreciate that the projecting of an image may be implemented in a variety of ways. The video driver 134 may for example be implemented with microprocessor 131. As projecting an image in accordance with a received video signal is known in the art, the processing of the video signal and the projecting will not be described in greater detail here.

The electronic reading device 100 further comprises an optical sensor unit 120. The optical sensor unit 120 may comprise a CCD sensor, a CMOS sensor, a PND sensor or the like. It scans the region surrounding the electronic reading device 100 by capturing a picture of the surrounding of the projection unit 110 through the lens system 120A. The optical sensor unit 120 may thus be implemented as a camera unit. The picture data captured by the optical sensor unit 120 is supplied to the microprocessor 131. The picture processing unit analyzes the picture data for a user controlled object. For this purpose, image processing is employed. The picture processing unit may for example use an edge detection algorithm for detecting features in the picture data, and it may use a recognition algorithm for recognizing objects in the captured image data. The picture processing unit may for example be configured to recognize a range of predetermined objects, such as a hand, a finger, a pen, a ring or a reflector. If for example a hand is placed in front of lens system 120A, the captured picture data comprises an image of the hand, which may then be recognized by the picture processing unit. The picture processing unit further detects a variation of a user controlled object and interprets it as a user input. Accordingly, a control signal is generated by the picture processing unit, in response to which the microprocessor 131 initiates the projecting of a video signal received from the connection unit 133 via the video driver 134 and the projecting unit 110. The picture processing unit may furthermore recognize the movement of a particular object, and interpret it as a command. Examples are the pointing to a particular position with a finger, the pushing of a particular position on the projection surface, e.g. the palm, with the finger or a pen.

The pushing of a particular position on the projection surface 140, e.g. with the finger or a pen, allows a user to operate the device with similar experience as reading a conventional paper book when turning a page. One may flick a book through the pages back and forth by pushing of a particular position on the projection surface 140 from left to right or from right to left with e.g. one's thumb (e.g. in case of portrait usage mode). This would bring “paper like reading” experience to the user. To completely mimic this page turning, the pushing of a particular position on the projection surface 140 could result in the electronic documents rotating around an axes upon the pushing action. Further, the picture processing unit may be configured to analyze shadows cast by a user controlled object, e.g. a finger. When the finger touches the projection surface, the shadow of the finger matches the finger. This can be detected as a user command.

The correction unit further analyzes properties of the projection surface imaged in the picture data supplied by the optical sensor unit 120. For example, when using a plastic plate or a desktop surface as a projection surface, the projection surface has a particular texture, color and curvature. The correction unit determines these properties, e.g. using image analysis, and performs a correction of the video signal supplied by the correction unit, so that the quality of the image projected by the projection unit 110 is improved. The correction unit may make use of any known image correction method in order to optimize the projected image. The correction unit may for example perform a color correction of the image, so that even on a colored projection surface the colors of the image are displayed as desired. For correction purposes, the correction unit may also work in a feedback configuration, wherein the properties of the projected image are tuned until the projected image exhibits the desired properties. The feedback signal in the form of captured picture data is delivered by the optical sensor unit 120 in this configuration.

The stabilization unit stabilizes the projecting of the image onto the projection surface 140. The stabilization unit may for example monitor the position of the projection surface in the captured picture data received from the optical sensor unit 120. The stabilization unit is implemented to drive a lens of a lens system 110A for image stabilization. By moving a lens of the lens system 110A, e.g. in a plane perpendicular to the optical axis of the lens system, the direction in which the image is projected, can be adjusted. The adjusting is performed by the stabilization unit in such a way that the image is stabilized on the projection surface 140. The stabilization unit may for example receive information on the position of the projection surface 140 from the microprocessor 131, and may then in accordance with that information send control signals to the lens system 110A. In another embodiment, the stabilization unit may comprise sensors for detecting a movement of the electronic reading device 100, such as inertial or motion sensors, data from which sensors is then used for stabilization purposes. In a further embodiment, an active mirror controlled by the stabilization unit may be used in order to adjust the position of the projected image. Those skilled in the art will appreciate that there are several possibilities of implementing the image stabilization, and that different methods may be combined, such as performing a stabilization using a software running on the microprocessor 131, or performing active stabilization using an electrically actuated mirror or moving lens. Those skilled in the art will appreciate that several other techniques for realizing such image stabilization may also be implemented in the electronic reading device of the present embodiment, e.g. stabilization by optical means.

Accordingly, by processing the picture data captured with the optical sensor unit 120 using the microprocessor 131, image correction and image stabilization can be performed, and user inputs can be detected. User commands detected by the picture processing unit are then supplied to the electronic device via the connection unit 133 and the connection cable or the Bluetooth™/® technology (not shown). In another embodiment, the captured picture data may be directly supplied to the electronic device, so that the electronic device can analyze the picture data for user commands.

The electronic reading device 100 of the present embodiment thus provides a display and user interface unit for an electronic device. It can be constructed in a small size and lightweight, so that it is easy to use. As an electronic device using such an electronic reading device does not require additional input or display means, the size of the electronic device can be reduced. It should be clear that the electronic reading device 100 may comprise further components, such as a battery, an input/output unit, a bus system, etc., which are not shown in FIGS. 3A and 3D for clarity purposes.

One skilled in the art will understand that the embodiment of the present invention as shown in the drawings and described above is exemplary only and not intended to be limited.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An electronic reading device comprising:
an eye glass frame; and
a camera-projection component mounted on said eye glass frame, comprising:
a projection unit to project an image onto a projection surface; and
an optical sensor unit to perform a scan of a region near said projection surface, wherein said optical sensor unit is configured to operate as a user interface by detecting a user input based on said scan.

2. The electronic reading device, as recited in claim 1, wherein said electronic reading device detects a user gesture on said projection surface and translates said detected gesture into a command to be performed.

3. The electronic reading device, as recited in claim 2, wherein said user gesture is one of a swipe and a rolling of a finger that has made contact with said projection surface to create the same page-turning experience as reading a conventional book.

4. The electronic reading device, as recited in claim 1, wherein said optical sensor unit is configured to capture picture data.

5. The electronic reading device, as recited in claim 4, wherein said electronic reading device further comprising a stabilization unit to stabilize said projected image based on said captured picture data.

6. The electronic reading device, as recited in claim 4, wherein the stabilization unit is configured to correct for movements of the projection surface.

7. The electronic reading device, as recited in claim 1, wherein said electronic reading device further comprising a picture processing unit to analyze picture data captured by said optical sensor unit for a user controlled object, wherein said picture processing unit is configured to detect a user input by detecting a variation of said user controlled object.

8. The electronic reading device, as recited in claim 7, wherein said user controlled object comprises at least one of a hand, a palm, a finger, a pen, a ring, or a reflector.

9. The electronic reading device, as recited in claim 1, further comprising a connection unit to establish a connection to an electronic device, wherein said electronic reading device being configured to operate as a display unit and as a user interface for said electronic device.

10. The electronic reading device, as recited in claim 9, wherein the connection is a wireless connection.

11. An electronic reading device comprising:
a camera-projection component mounted on said eye glass frame, comprising:
a projection unit to project an image onto a projection surface; and
an optical sensor unit to perform a scan of a region near said projection surface, wherein said optical sensor unit is configured to operate as a user interface by detecting a user input based on said scan;
a holder being configured to secure said electronic reading device with said projection surface; and
a bendable arm being configured to connect said holder to said camera-projection component.

12. The electronic reading device, as recited in claim 11, wherein said electronic reading device detects a user gesture on said projection surface and translates said detected gesture into a command to be performed.

13. The electronic reading device, as recited in claim 12, wherein said user gesture is one of a swipe and a rolling of a finger that has made contact with said projection surface to create the same page-turning experience as reading a conventional book.

14. The electronic reading device, as recited in claim 11, wherein said optical sensor unit is configured to capture picture data.

15. The electronic reading device, as recited in claim 14, wherein said electronic reading device further comprising a stabilization unit to stabilize said projected image based on said captured picture data.

16. The electronic reading device, as recited in claim 14, wherein the stabilization unit is configured to correct for movements of the projection surface.

17. The electronic reading device, as recited in claim 11, wherein said electronic reading device further comprising a picture processing unit to analyze picture data captured by said optical sensor unit for a user controlled object, wherein said picture processing unit is configured to detect a user input by detecting a variation of said user controlled object.

18. The electronic reading device, as recited in claim 17, wherein said user controlled object comprises at least one of a hand, a palm, a finger, a pen, a ring, or a reflector.

19. The electronic reading device, as recited in claim 11, further comprising a connection unit to establish a connection to an electronic device, wherein said electronic reading device being configured to operate as a display unit and as a user interface for the electronic device.

20. The electronic reading device, as recited in claim 19, wherein the connection is a wireless connection.
